(19) United States
(12) Patent Application Publication
(10) Pub. No.: US 2019/0205923 A1
(43) Pub. Date: Jul. 4, 2019

(54) SYSTEM AND METHOD FOR CAPTURING AND MEASURING AUDIENCE FEEDBACK

(71) Applicant: VINAY RAI, Bangalore (IN)

(72) Inventor: VINAY RAI, Bangalore (IN)

(21) Appl. No.: 16/299,133

(22) Filed: Mar. 11, 2019

Related U.S. Application Data
(63) Continuation-in-part of application No. 16/085,592, filed on Sep. 17, 2018.

(30) Foreign Application Priority Data
Mar. 18, 2016 (IN) 201641009586

(51) Int. Cl. G06Q 30/02

(52) U.S. Cl. CPC G06Q 30/0246; G06Q 30/0272; G06Q 30/0277; G06Q 30/0276

(57) ABSTRACT

The embodiments herein provide a method and system for capturing, measuring and analyzing audience feedback. The system includes a plurality of client devices and a server. The server includes an objective module, a publishing module, and a feedback module. A content/objective creator creates an online content/objective using pre-determined objectives available in the objective module and publishes the content/objective using the publishing module. The created content/objective is transmitted to the client devices for receiving feedback on the created online content/objective. The feedback module receives the feedback from the audience and analyses the audience perception of the content/objective created online.

### CROSS-REFERENCE TO RELATED APPLICATION

This patent application is a CIP application filed in continuation of the U.S. Ser. No. 16/085,592 filed on Sep. 17, 2018 and which is a National Phase application filed in USPTO corresponding to the PCT Application No. PCT/IN2017/050093 filed on Mar. 16, 2017 with the title “A SYSTEM AND METHOD FOR CAPTURING AND MEASURING AUDIENCE FEEDBACK”. This patent application claims the priority of the Indian Provisional Patent Application No. 201641009586 filed on Mar. 18, 2016 with the title “A SYSTEM AND METHOD FOR CAPTURING AND MEASURING AUDIENCE FEEDBACK”, the contents of which is included entirely herein by way of reference.

### BACKGROUND

### Technical Field

The embodiments herein are generally related to analytical measurement systems and methods. The embodiments herein are particularly related to a system and method for capturing and analysing behaviour of a crowd or public. The embodiments herein are more particularly related to a system and method for measuring audience emotions and crowd analytics. The embodiments herein are especially related to a system and method for configuring Artificial Intelligence (AI) to achieve a desired objective.

### Description of the Related Art

Publishing refers to a process of production and dissemination of literature, music, or any other information available to the general public. A content is published using both traditional publishing channels and online publishing tools. The content published online has comparatively wide variety of audiences.

The currently available publishing tools, particularly for the online content, lack an effective mechanism for measuring a perception of the content published. This causes difficulty for advertisers and others to publish a content online, and to measure, understand and analyse the perception of the audience.

Configuring refers to a process of configuring AI as a DNA model D stands for Device, N stands for Neural Network and A stands for Action/Analytics. The configured DNA can be used to address a variety of problems.

Currently available tools, particularly for AI, lack an effective mechanism for configuring AI thereby causing difficulty for the users and others to define an online objective based on AI based objective and to measure, understand and analyse the perception of the audience.

Hence, there is a need for a method and system for providing a platform for understanding a perception of the audience for the content published online. Further, there is a need for a method and system for analysing crowd emotions based on the content published online. Still further, there is a need for a system and method for engaging the audience with the content published online. Yet further there is a need for a method and system for providing a platform for solving a plurality of problems by configuring AI online. Yet further, there is a need for a method and system for analysing data based on the configured AI. Yet further, there is a need for a system and method for solving problems with the configured AI.

The above-mentioned shortcomings, disadvantages and problems are addressed herein and which will be understood by reading and studying the following specification.

### OBJECT OF THE EMBODIMENTS HEREIN

The embodiments herein provide a system and method for capturing, measuring, and analysing audience feedback effectively.

The primary object of the embodiments herein is to provide a system and method for analysing a crowd behaviour based on a content published online.

Another object of the embodiments herein is to provide a system and method for transmitting a plurality of survey forms and links through online services.

Yet another object of the embodiments herein is to provide a system and method for measuring a feedback received from the audience based on a plurality of pre-determined parameters.

Yet another object of the embodiments herein is to provide a system and method for creating new objectives based on the audience feedback.

Yet another object of the embodiments herein is to provide a system and method for analysing a crowd behaviour based on a plurality of objectives published online.

Yet another object of the embodiments herein is to provide a system and method for transmitting a plurality of objectives and links through online services.

Yet another object of the embodiments herein is to provide a system and method for measuring a feedback received from the audience based on a plurality of pre-determined parameters.

Yet another object of the embodiments herein is to provide a system and method for creating new objectives based on the plurality of predetermined parameters.

These and other objects and advantages embodiment herein will become readily apparent from the following detailed description taken in conjunction with the accompanying drawings.

### SUMMARY

The embodiments herein provide a system for capturing, measuring and analysing audience feedback for media content created online. The system comprises a plurality of client devices configured for rendering the created media content and capturing an audience feedback. The plurality of client devices comprise a computing device. The system also comprises a server connected to the plurality of client devices through a communication network and configured for facilitating a content creator to create and publish the media content to the plurality of client devices and analyse the feedback received from the plurality of client devices. The server comprises an objective module configured for allowing the content creator to define an objective associated with the media content by providing a plurality of pre-determined objectives and corresponding templates. The server also comprises a publishing module configured for allowing the content creator to publish/broadcast the media content and associated objective to the plurality of client devices. The published media content and associated objective is viewed on the plurality of client devices. The server further comprises a feedback module configured for receiving a feedback related to the published media content from the audience through the plurality of client devices. The feedback module is further configured for analysing the perception of the published media content based on, a plurality of pre-determined parameters set by the content creator.

According to an embodiment herein, the content creator is provided with an option to select one of the pre-determined templates or configure a pre-determined template for defining the objective.

According to an embodiment herein, the server is further configured for transmitting the media content and associated objective to the plurality of the client devices through a dedicated campaign created by the content creator.

According to an embodiment herein, the content creator is allowed to specify a timeline for the delivery of the campaign to the plurality of client devices and to set a duration for which the campaign is run on the plurality of client devices. The execution of the campaign on the plurality of client devices is terminated, when the period/time of running the execution the campaign exceeds the preset duration.

According to an embodiment herein, the content creator is allowed to specify a point of expiry for a campaign. The point of expiry is a target at which the objective of the campaign is achieved. The execution of the campaign on the plurality of client devices is terminated on achieving the specified target.

According to an embodiment herein, each client device is configured for executing a call-out-text, when a potential audience is in the proximity of the client device but not close enough to engage with the client device. The call-out-text is defined by the content creator as a part of the objective.

According to an embodiment herein, the server is further configured for sharing one or more reports, campaign data and analysis information related to the campaign with the content creator via a cloud interface.

According to an embodiment herein, the feedback received from the audience through the plurality of client devices further comprises a unique code for identifying each client device.

According to an embodiment herein, a method for capturing, measuring and analysing audience feedback for a media content created online is provided. The method comprises the steps of allowing the content creator to define an objective associated with the media content by providing a plurality of pre-determined objectives and corresponding templates using an objective module. The content creator is allowed/enabled to publish/broadcast the media content and associated objective to the plurality of client devices using a publishing module. The published media content and associated objective is viewed on the plurality of client devices. A feedback related to or with respect to the published media content is received from an audience through the plurality of client devices using a feedback module. The perception of the published media content is analysed based on a plurality of pre-determined parameters set by the content creator using the feedback module. One or more reports, campaign data and analysis information related to the campaign are generated with the content creator through a cloud interface.

According to an embodiment herein, the method further comprises specifying a timeline for the delivery of the campaign to the plurality of client devices and setting a duration for which the campaign is run on the plurality of client devices by a content creator. The execution of the campaign on the plurality of client devices is terminated when the preset duration for running the campaign is exceeded.

The embodiments herein provide a method and system for configuring AI as a DNA model mentioned above. According to an embodiment herein, the system is configured for solving a problem created online. The system includes a plurality of client devices and a server. The server includes an objective module, a publishing module, and a feedback module.

According to an embodiment of the present invention, the system is configured to allow a creator to generate an objective using the DNA model, to transmit the objective to a plurality of client devices and to receive the analytics from the published model. The objective module is configured to allow the objective creator to select a plurality of pre-determined templates for creating an objective. The objective module is also configured to allow the objective creator to create a new template for creating an objective.

Once the objective is created using the DNA module, die publishing module is configured to allow the objective creator to publish the objective online. The published objective is transmitted to the plurality of client devices through a communication network.

The feedback module is configured to receive the analytics from the audiences and analyse the perception of the objective based on a plurality of pre-determined parameters set by the objective creator.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a system for capturing, measuring and analysing audience feedback, according to one embodiment herein.

FIG. 2 illustrates a block diagram of an application server on a cloud in a system for capturing, measuring and analysing audience feedback, according to one embodiment herein.

FIG. 3 illustrates a block diagram of a database server on a cloud in a system for capturing, measuring and analysing audience feedback, according to one embodiment herein.

FIG. 4 illustrates a flow chart explaining a method of capturing, measuring and analysing audience feedback, according to one embodiment herein.

Although the specific features of the embodiment herein are shown in some drawings and not in others. This is done for convenience only as each feature may be combined with any or all of the other features in accordance with the embodiments herein.

### DETAILED DESCRIPTION OF THE EMBODIMENTS HEREIN

In the following detailed description, a reference is made to the accompanying drawings that form a part, hereof, and in which the specific embodiments that may be practiced is shown by way of illustration. These embodiments herein are described in sufficient detail to enable those skilled, in the art to practice the embodiments and it is to be understood that the logical, mechanical and other changes may be made without departing from the scope of the embodiments. The following detailed description is therefore not to be taken in a limiting sense.

The embodiments herein are provide a system for capturing, measuring and analysing audience feedback for media content created online. The system comprises a plurality of client devices configured for rendering the created media content and capturing an audience feedback. The plurality of client devices comprise a computing device. The system also comprises a server connected to the plurality of client devices through a communication network and configured for facilitating a content creator to create and publish the media content to the plurality of client devices and analyse the feedback received from the plurality of client devices. The server comprises an objective module configured for allowing the content creator to define an objective associated with the media content by providing a plurality of pre-determined objectives and corresponding templates. The server also comprises a publishing module configured for allowing the content creator to publish/broadcast the media content and associated objective to the plurality of client devices. The published media content and associated objective is viewed on the plurality of client devices. The server further comprises a feedback module configured for receiving a feedback related to the published media content from the audience through the plurality of client devices. The feedback module is further configured for analysing the perception of the published media content based on a plurality of pre-determined parameters set by the content creator.

According to an embodiment herein, the content creator is provided with an option to select one of the pre-determined templates or configure a pre-determined template for defining the objective.

According to an embodiment herein, the server is further configured for transmitting the media content and associated objective to the plurality of the client devices through a dedicated campaign created by the content creator.

According to an embodiment herein, the content creator is allowed to specify a timeline for the delivery of the campaign to the plurality of client devices and to set a duration for which the campaign is run on the plurality of client devices. The execution of the campaign on the plurality of client devices is terminated, when the period/time of running the execution the campaign exceeds the preset duration.

According to an embodiment herein, the content creator is allowed to specify a point of expiry for a campaign. The point of expiry is a target at which the objective of the campaign is achieved. The execution of the campaign on the plurality of client devices is terminated on achieving the specified target.

According to an embodiment herein, each client device is configured for executing a call-out-text, when a potential audience is in the proximity of the client device but not close enough to engage with the client device. The call-out-text is defined by the content creator as a part of the objective.

According to an embodiment herein, the server is further configured for sharing one or more reports, campaign data and analysis information related to the campaign with the content creator via a cloud interface.

According to an embodiment herein, the feedback received from the audience through the plurality of client devices further comprises a unique code for identifying each client device.

According to an embodiment herein, a method for capturing, measuring and analysing audience feedback for a media content created online is provided. The method comprises the steps of allowing the content creator to define an objective associated with the media content by providing a plurality of pre-determined objectives and corresponding templates using an objective module. The content creator is allowed/enabled to publish/broadcast the media content and associated objective to the plurality of client devices using a publishing module. The published media content and associated objective is viewed on the plurality of client devices. A feedback related to or with respect to the published media content is received from an audience through the plurality of client devices using a feedback module. The perception of the published media content is analysed based on a plurality of pre-determined parameters set by the content creator using the feedback module. One or more reports, campaign data and analysis information related to the campaign are generated with the content creator through a cloud interface.

According to an embodiment herein, the method further comprises specifying a timeline for the delivery of the campaign to the plurality of client devices and setting a duration for which the campaign is run on the plurality of client devices by a content creator. The execution of the campaign on the plurality of client devices is terminated when the preset duration for running the campaign is exceeded.

The embodiments herein provide a method and system for configuring AI as a DNA model mentioned above. According to an embodiment herein, the system is configured for solving a problem created online. The system includes a plurality of client devices and a server. The server includes an objective module, a publishing module, and a feedback module.

According to an embodiment of the present invention, the system is configured to allow a creator to generate an objective using the DNA model, to transmit the objective to a plurality of client devices and to receive the analytics from the published model. The objective module is configured to allow the objective creator to select a plurality of pre-determined templates for creating an objective. The objective module is also configured to allow the objective creator to create a new template for creating an objective.

Once the objective is created using the DNA module, the publishing module is configured to allow the objective creator to publish the objective online. The published objective is transmitted to the plurality of client devices through a communication network.

The feedback module is configured to receive the analytics from the audiences and analyse the perception of the objective based on a plurality of pre-determined parameters set by the objective creator.

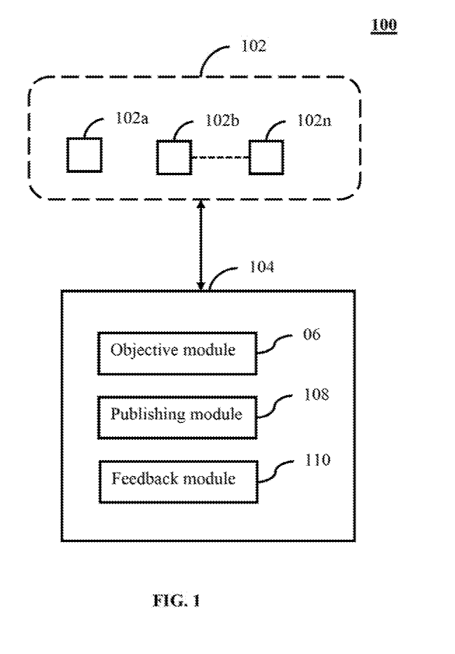

FIG. 1 illustrates a block diagram of a system for capturing and measuring audience emotions, according to one embodiment herein. The system includes a plurality of client devices 102a, 102b . . . 102n and a server 104. The server includes a plurality of modules which include an objective module 106, a publishing module 108, and a feedback module 110.

According to an embodiment herein, the system provides a tool to analyse the streams of data pertaining or related to a defined objective and provide data or datasets to deduce patterns, statistics and data analytics with respect to the defined objective. A media content/objective is transmitted to the plurality of the client devices 102a, 102b . . . 102n from the server 104 with a defined objective. Further, the server 104 receives the feedback from the plurality of the client devices 102a, 102b . . . 102n based on the defined objective. The received feedback is used for measuring and analysing audience feedback and audience emotions.

The client device 102 is a computing device used for rendering the media content/objective and capturing audience feedback and emotions. The media content/objective is rendered to the plurality of the client devices 102a, 102b . . . 102n through the server 104. The examples of the client device 102 include, but are not limited to a mobile phone, a laptop, a desktop computer, a smartphone, a tablet computer, a wearable device, a smart television, a gaming console, and the like. According to an embodiment herein, the client device 102 is connected to a high-speed microprocessor and a digital display.

The media content/objective is transmitted to the client device 102 from the server 104 through a communication network (not shown in the figure). The examples of the communication network include, but are not limited to the internet, an intranet, a telephonic network, a radio communication network, and the like.

The server 104 is a computing device that provides functionality for the plurality of the client devices 102a, 102b . . . 102n. According to an embodiment herein, the server 104 includes an application server, a database server and a data server. The server 104 is connected to the client device through the communication network. The application server hosts a service based application. The service based, application has services which serve a web interface and a mobile interface. According to an embodiment herein, the application server also hosts an interface where a content/objective creator logs in to define the objective. The data server is configured to store the response data of each feedback received for a media content/objective published.

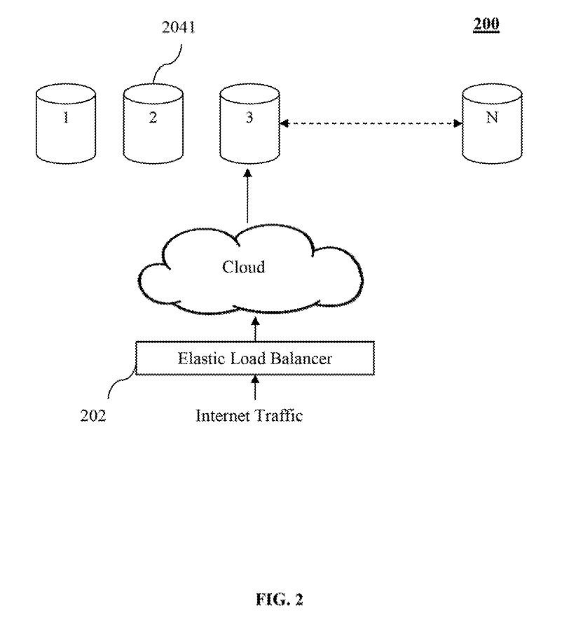

According to one embodiment herein, the application server is hosted on a cloud using on demand computing resources as shown in FIG. 2. All the request received via internet from the users/publishers are served by an elastic load balancer (ELB) 202 which further forwards the request to the application server hosted on the virtual machine. The request is forwarded to the application server based on load on the virtual machine. The ELB is configured to balance/adjust the load or burden by equally distributing the load across all application server instances. The application server instances are also deployed in a plurality of available zones/regions 204 and are dynamically scaled based on the internet traffic.

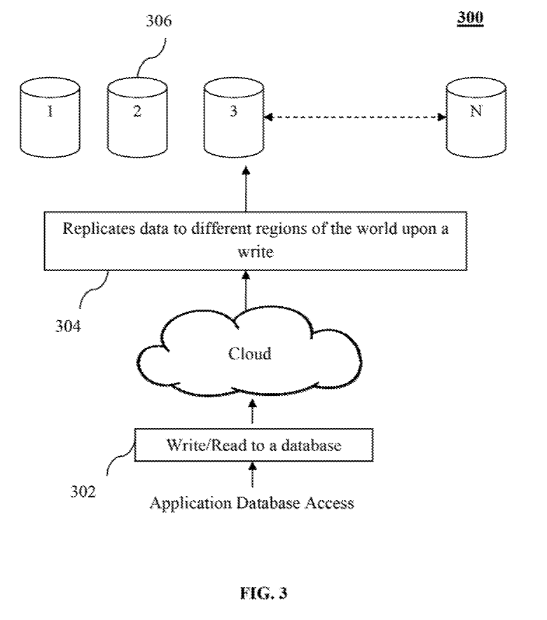

According to one embodiment herein, the database server is also hosted on the cloud using on demand computing resources as shown in FIG. 3. Any write or read activity 302 to the database is replicated across all the database instances 306 in different regions of the world (304). Thus, the write or read request from the user is served from the database instance based on the load. This system (deployment model) is configured to distribute the processing load equally distribute across a plurality of database instances along with a data consistency.

The objective module 106 included in the server 102, is configured to define an objective for the client device 102. According to an embodiment herein, the objectives are defined by the content/objective creator. The content/objective creator is configured to generate a plurality of objectives that are hosted on the server 104. The content/objective creator logs into an account for creating the objective. According to an embodiment herein, the objective is defined using a cloud facing interface. The examples of the cloud facing interface include, but are not limited to a web interface, a mobile application, and the like. According to an embodiment herein, the objective module 106 includes a plurality of pre-determined objectives with well-defined templates. The content/objective creator has an option to select one of the pre-determined templates and create new templates.

Once the objective is defined, the publishing module 108 is run on a hardware processor and is configured to allow the user to publish the objective to the client device 102. The published content/objective includes the objective defined and is viewed on the client device 102. The audience for the published media content/objective is enabled to access the content/objective by logging to a client software. According to an embodiment herein, the published media content/objective is displayed on a digital screen of the computing device for the audience to view and engage directly with gestures and/or mobile device.

According to an embodiment herein, the digital screen captures the user interaction via gesture recognition and mobile QR code interaction using an inbuilt depth camera.

According to an embodiment herein, the plurality of well defined templates includes a feedback template. The content/objective creator is configured to broadcast the feedback template listed with the questions for receiving an audience feedback along with possible outcomes or answers of the questions. An example of a question is whether you like our service? The possible answers that are received from the audience are 1) Yes, or 2) No, or 3) Undecided. When the content/objective creator is configured to broadcast this feedback template on the client device, the audience coming within the range of the client device is prompted with this question to provide their response. The audience is provided with an option to choose an answer using gestures. Further, instantaneous reports on the participation of audience and a plurality of associated metrics are sent to the content/objective creator.

According to an embodiment herein, the plurality of well defined templates includes a voucher redemption template provided to the audience. This voucher redemption template is configured to help the business owners or store managers to track an audience on a purchase process or buying process by promoting a product by giving freebies. The business owners or store managers are allowed or/facilitated to configure number of vouchers to be given away using the voucher redemption template. For example, for a set target of 100 vouchers the system encodes the voucher details in the form of a QR code and enables the business owner or store manager to send an email to the target audience along with the venue details. The recipient receiving the QR code needs to flash the QR code to get the freebie on reaching the venue where client device is placed. The client device is enabled to read the QR code along with user details for giving instantaneous feedback to the store manager. The client device is further configured to dispense the requested product when integrated with a vending machine.

According to an embodiment herein, the plurality of well defined templates includes an event registration provided to the audience includes template. This template is similar in functionality to the voucher redemption template except that the event manager is configured to create the QR code and send the created QR code to the invitees based on the invitee's details like email address, phone number etc. The recipients receiving the QR code need to flash the received QR code to register themselves on reaching the venue where the client device is placed. The client device is enabled to read the QR code along with the user details for providing an instantaneous report on the attendance and participation along with a headcount to the event manager.

According to an embodiment herein, the plurality of well defined templates includes a queue management template provided to the content/objective creator. This template is used in managing a queue of audience/visitors in a bank for bank professionals or clinic for a doctor. This template is operated easily and is broadcasted by the client device placed at the venue/site. The client device is configured to automatically capture the visitors entering the venue based on a time stamp. For example, in case 4 people entering the venue at 1st, 2nd, 3rd and 4th second or millisecond, the client device is configured to automatically queue them up and prepare/generate a queue list based on the time of entering the venue and thereby eliminating a necessity or need for a token based system. The generated queue list is presented or forwarded to the doctor or bank professionals to close the queue after processing each visitor. The system is configured to automatically notify the next visitor regarding/about ones turn on a digital display.

According to an embodiment herein, the plurality of well defined templates includes a security template. This security template is generated and employed or provided in places or areas where security is a major concern. The places include a multinational company (MNC) or a special economic zone (SEZ). The security teams or security systems in a high secure areas or intense security requiring areas are configured to usually take pictures of guest visitors to print the access passes for the visitors. The security template provided and broadcasted by the client device is configured to automatically take pictures using face tracking algorithm and presents/provides/forwards these pictures to the security team without a need of manually focusing on each visitor and processing the visitors sequentially (one after another). According to one embodiment, the client device is configured to process up to six visitors to increase an efficiency of the security team or security system by printing the necessary or required passes.

According to an embodiment herein, an interactive advertisement and POS template is provided to the content creator. Any company/brand is allowed or configured to effectively undertake several tasks simultaneously through this template in combination with a mobile application provided by the system. According to one embodiment herein, an advertisement is provided as a point of sale through the template to receive reports and orders at real time, when the system is configured to advertise and engage audience using mixed reality without any wearable device.

According to one embodiment herein, an interactive advertisement and POS template is best used in a plurality of scenarios or use cases. In a first use case/scenario, the audience/user need to download and register on the mobile application provided by (downloaded from) the system which automatically segregates the user details as shopping profile, social profile, professional profile and personal profile. Further, the users are allowed to choose the profile to effectively interact with the system depending on the use case or scenario.

In a second use case or scenario, the system is configured to enable/allow the business organizations to broadcast the advertisement on multiple client devices placed at strategic locations based on their choice. The audience coming in contact with the client device is engaged using mixed reality options to sell the products by interacting with the audience by providing several exciting options. When the audience like the product viewed by the audience or displayed on the digital display, the audience are allowed to flash their appropriate profile from their mobile application to place an order or callback/contact based on a plurality of requirements. This information is encrypted for transmission and then decrypted for processing. The plurality of the requirements include, audience using their shopping profile QR code to place orders at the client device, audience using their professional profile to register themselves for a new job, audience using their social media profile to register themselves for an event and the like.

According to an embodiment herein, the audience use their shopping profile QR code to place orders at the client device. The purchased product is shipped to their address with cash on delivery (COD) facility and/or buy the product through a mobile application.

According to an embodiment herein, a power presentation template is provided to the content creator. This power presentation template is configured to enable or allow the business organizations to present their products online to the audience through a mixed AV reality environment. The audience is allowed to see or view the product presentation in mixed AV reality environment. The audience use gestures to slide back and forth or move the presentation, load a video etc. The audience is further allowed to see or view and listen the content creator speech or report along with the presentation.

According to an embodiment herein, an order management template is provided to the content/objective creator. This order management template template is configured to enable a store manager to create a virtual mixed reality ordering system for the audience. Once broadcasted, this template is configured to enable the audience to choose products in the store through gestures where the audience virtually fills their respective basket by choosing and placing the selected products in the basket. The system is configured to provide the audience a real time price of the total order and allow a checking out anytime through gestures or by walking out of the digital display. The audience is also facilitated to register for loyalty programs of the store with ease. The client device is configured to recognize a returning audience registered for the store's loyalty program. Further, the client device is configured to process up to six-audience simultaneously and reports back die analytics or process result or report to the store manager regarding the headcount, the total orders processed, the number of returning audience etc.

According to an embodiment herein, a mixed reality engagement template is provided to the content creator. The template is configured to allow or enable the store manager to configure/facilitate an audience digital engagement through a plurality of mixed reality parameters such as facial parameters for a lipstick. The store manager uploads all the color shades of the lipstick and enables the audience to place an order based on whether they like the color or not. When the audience engages with the client device, the shades of selected color is automatically shown/exhibited/displayed on their lips thereby providing a preview of a lip applied with a selected among a plurality of colors or an appearance of lips at a plurality of colors when a respective color is applied on the lip. The mixed reality is customizable for bags, jewelry and wide range of accessories.

According to an embodiment herein, a customizable application template is provided to the content/objective creator. This template is configured to enable or allow any company/brand to permit an audience to create their own product using DIY concept using their mobile phones and translates to a QR code. When this QR code is flashed to the client device, the client device in conjunction with appropriate vending machine makes the product available to the audience. The audience is further allowed to gift this QR code to their loved ones to redeem the gift at a vending machine integrated with the client device. For example, a customer willing to make a special type of coffee to a loved one, simply uses the mobile application provided by the proposed system to choose the type of coffee, the toppings along with a personalized message and sends the customized coffee to his/her loved one. The recipient then walks to a nearest client device integrated with vending machine and flashes the QR code. The vending machine makes the coffee as per the choices made by the sender and prints out the personalized message.

According to an embodiment herein, the client device is configured to communicate with vending machines placed aside the client device through Bluetooth to directly dispense the product upon purchase.

According to an embodiment herein, the feedback module 110 is configured to receive the feedback from a plurality of audiences through the plurality of the client devices 102a, 102b . . . 102n. The feedback is received through a communication network. According to an embodiment herein, the period of the feedback reception is subject to the objective defined by the objective module 104. The feedback module 110 is configured to receive both general and specific feedback based on the media content/objective published. The received feedback is analysed on a plurality of pre-determined parameters. The pre-determined parameters are set by the content creator. The feedback sent by the audience has a unique code to identity the client device. The examples of the unique code include, but are not limited to device code, QR code, user identity and the like.

According to an embodiment herein, the plurality of analysis techniques used by the feedback module comprise analysing whether a gender of the person answering the questions for feedback is a male or a female (after ensuring that the person does not answer a question more than once). Other analysis techniques include collating the total number of people who have entered a zone where the client device is present and then segregating the data into a total number of people present at a venue, number of people who engaged with the client device, number of people who have answered all the questions, number of male, number of female and the like.

According to an embodiment herein, the media content/objective is transmitted to the plurality of the client devices 102a, 102b . . . 102n through a dedicated campaign created by the content/objective creator. In this context, a campaign refers to a media content/objective executed on the plurality of the client devices 102a, 102b . . . 102n. Further, the user has an option to specifically name the campaign through an identification associated with the campaign. According to an embodiment herein, the content/objective creator is allowed to provide timelines for the delivery of the campaign. For example, when the content/objective creator sets the delivery time as 1 May 2016, the media content/objective in that particular campaign is delivered to the client devices on May 1, 2016.

According to an embodiment herein, the content/objective creator is allowed to set a duration/time period for running the campaign on the client device 102. Once the running time of the campaign exceeds the pre-set duration, the execution of the campaign on the plurality of the client devices 102a, 102b . . . 102n is terminated.

According to an embodiment herein, a call-out-text is executed, when a potential audience is present near (in the proximity of) the client device 102, but not close enough to engage with the client device 102. Further, the content/objective creator has an option to include a greeting text for the audience when the audience is captured and attempts to directly engage with the client device 102.

The objective module 106 is configured to execute a plurality of functionalities/functions. The examples of the functionalities/functions include, but are not limited to audience impression, opinion, security control, and the like.

According to an embodiment herein, the audience impression template allows the content/objective creator to define the objective with a creative, to configure questions and associates gestures to the questions, and the like. Further, the content/objective creator is also provided with an option to create open and close ended questions and set the requirement (mandatory or optional) for the audience to answer that question. For example, when a content/objective creator chooses to capture an audience feedback, then he/she chooses an audience feedback template from the cloud interface and types in the questions for receiving a response from the audience. Further, the content/objective creator is configured to broadcast the media content and the objective to all the locations from where the audience feedback is desired/required.

According to an embodiment herein, the user impression has a window to enable the audience to view oneself on the digital display associated with the defined creative. Further, the users of the client device 102 also have the option to take a picture with the content. For example, the user is prompted to take a self-portrait/selfie with the advertisement, when the user is successfully engaged with the client device. The display prompts the user with a QR code, on scanning which the selfie is downloaded on user mobile phone. Further, the user is prompted to post this selfie on social networking sites such as Facebook, twitter etc., thereby enabling a static advertisement to generate impression on social network.

According to an embodiment herein, the content/objective creator has an option to define the objective by means of a comparison with the template provided in the objective module 106. The audiences are provided with an option to engage with the client device 102 until the face engages with a one of the two comparisons made. Further, the user has an option to create a security control, where the user defines the security features of the campaign such as facial recognition.

According to an embodiment herein, the client device 102 includes a device client software. The device client software includes a plurality of algorithms that are executed or run based on the objective data structure received from the server 104. For example, a polling algorithm is run and configured to make the server to poll to acquire the campaign status (terminated, broadcasting or offline). A data transfer algorithm is run and configured to push the data to the server based on the broadcast content. In this example, there are about 12 mandatory data points which deal with the user's demographics and the rest are tailor-made pertaining to the campaign. Other example of the device client software algorithm includes a third party facial recognition algorithm which determines data pertaining to the user.

According to an embodiment herein, the templates defined in the objective module 106 is configured to dictate the behaviour of the client device 102 in terms of data capture, engaging the audience, recording the gestures with respect to the digital content published on the device.

According to an embodiment herein, the client device captures the user interaction via gesture recognition and mobile QR code interaction using an inbuilt depth camera.

According to an embodiment herein, the response data includes a plurality of formats. An example of the response format includes a device unique identification, a campaign unique identification, a sub-responses including gender of the audience, age group of the audience, response to the question, date, time, opinion, and the like.

According to an embodiment herein, the user is further facilitated with a mobile application that is hosted on the computing device of the user. In one example embodiment, the user is allowed to customize a plurality of buying options through the mobile application. For example, the user is allowed to customize a recipe for beverage, food or any other consumable item via the mobile application running of the user's smart phone. The client device then uses this customized information for preparing the food item for that particular user or provides this information to another connected device for preparation of the food item.

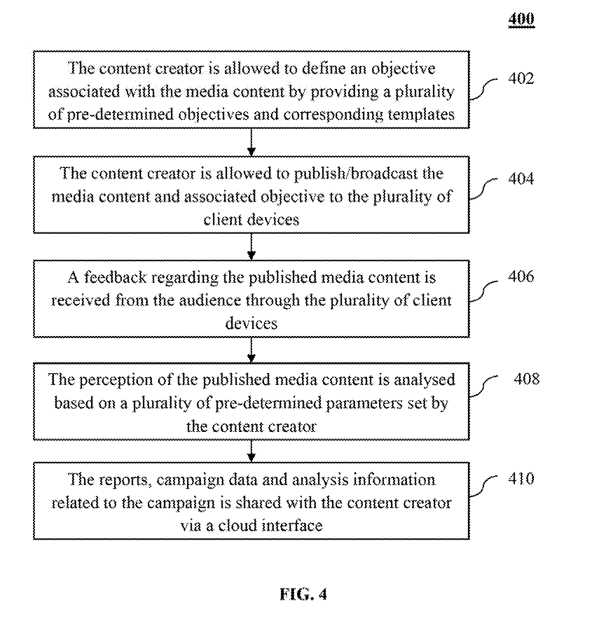

FIG. 4 illustrates a flow chart explaining a method of capturing, measuring and analysing audience feedback, according to one embodiment herein. With respect to FIG. 4, the method comprises allowing the content/objective creator to define an objective associated with the media content by providing a plurality of pre-determined objectives and corresponding templates using an objective module (402). The content/objective creator is provided with an option to select one of the pre-determined templates or configure a pre-determined template for defining the objective. The content/objective creator is allowed to publish/broadcast the media content/objective and associated objective to the plurality of client devices using a publishing module (404). The published media content and associated objective are viewed on the plurality of client devices. A feedback regarding the published media content/objective is received from the audience through the plurality of client devices using a feedback module (406). The perception of the published media content/objective is analysed based on a plurality of pre-determined parameters set by the content/objective creator using the feedback module (408). The reports, campaign data and analysis information related to the campaign are sharing with the content/objective creator through a cloud interface (410).

The embodiments herein provide a method and system for capturing and measuring audience responses. The embodiment herein provides a user engagement platform for an audience to the digital content. Further, the embodiment herein provides a mechanism in which the users engaging with the digital content/objective are treated as the source of propagating the digital content/objective through a plurality of social networking sites. The embodiment herein also allows the content/objective creators to analyse the behaviour of the audience dynamically. The embodiments herein allow the campaign creators to modify the content/objective published online by initially engaging a smaller set of audience.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A system for capturing, measuring and analysing audience feedback for media content/objective created online, the system comprising:
a plurality of client devices configured for rendering a media content/objective and for capturing an audience feedback, and wherein the plurality of client devices comprise a computing device;
a server connected to the plurality of client devices through a communication network, and wherein the server is configured to allow a content/objective creator to create and publish the media content/objective to the plurality of client devices and wherein the server is configured to analyse a feedback received from the plurality of client devices;
an objective module provided in the server and wherein the objective module is configured to allow the content/objective creator to define an objective by providing a plurality of pre-determined objectives and corresponding templates;
a publishing module provided in the server and wherein the publishing module is configured for allowing the content/objective creator to publish/broadcast the media content/objective and associated objective to the plurality of client devices, and wherein the published media content/objective and associated objective are viewed on the plurality of client devices; and
a feedback module provided in the server and wherein the feedback module is configured for receiving a feedback regarding the published media content/objective from the audience through the plurality of client devices, and wherein the feedback module is further configured for analysing a perception of the published media content/objective based on a plurality of pre-determined parameters set by the content/objective creator;
and wherein the content/objective creator is allowed to specify a point of expiry for a campaign, and wherein the point of expiry is a target for achieving an objective of the campaign is achieved, and wherein the execution of the campaign on the plurality of client devices is terminated when the specified target is achieved, and wherein each client device is configured to execute a call-out-text, when a potential audience is present in the proximity of the client device but not close enough to engage with the client device, and wherein the call-out-text is defined by the content/objective creator, and wherein the call-out-text is formed or provided as a part of the objective.

2. The system according to claim 1, wherein the content/objective creator is provided with an option to select one of the pre-determined templates or configure a pre-determined template for defining the objective.

3. The system according to claim 1, wherein the server is further configured to transmit the media content/objective and associated objective to the plurality of the client devices through a dedicated campaign created by the content creator.

4. The system according to claim 1, wherein the content/objective creator is allowed to specify a timeline for a delivery of the campaign to the plurality of client devices and wherein the content/objective creator is configured to set a duration for running the campaign on the plurality of client devices, and wherein an execution of the campaign on the plurality of client devices is terminated when a running time of the campaign exceeds the set duration.

5. The system according to claim 1, wherein the server is further configured to share one or more reports, campaign data and analysis information related to the campaign with the content/objective creator via a cloud interface.

6. The system according to claim 1, wherein the feedback received from the audience through the plurality of client devices comprises a unique code for identifying each client device.

7. A computer implemented method comprising instructions stored on a non-transitory computer readable storage medium and run on a computing device provided with a hardware processor and memory for capturing, measuring and analysing audience feedback for a media content/objective created online, the method comprising the steps of:
allowing the content/objective creator to define an objective (associated with the media content) by providing a plurality of pre-determined objectives and corresponding templates using an objective module;
allowing the content/objective creator to publish/broadcast the media content/objective and associated/defined objective to the plurality of client devices through a publishing module, and wherein the published media content/objective and associated/defined objective is viewed on the plurality of client devices;
receiving a feedback regarding the published media content/objective from the audience through the plurality of client devices through a feedback module;
analysing the perception of the published media content/based on a plurality of pre-determined parameters set by the content/objective creator, with the feedback module; and
sharing one or more reports, campaign data and analysis information related to the campaign with the content/objective creator through a cloud interface.

8. The method according to claim 7, further comprises:
specifying a timeline for the delivery of the campaign to the plurality of client devices;
setting a duration for running the campaign on the plurality of client devices by a content/objective creator, and wherein the execution of the campaign on the plurality of client devices is terminated when running time of the campaign on the plurality of devices exceeds set duration.
